(19) United States
(12) Patent Application Publication
(10) Pub. No.: US 2017/0351864 A1
(43) Pub. Date: Dec. 7, 2017

(54) INFORMATION PROCESSING SYSTEM, INFORMATION PROCESSING APPARATUS, NON-TRANSITORY COMPUTER READABLE MEDIUM, AND INFORMATION PROCESSING METHOD

(71) Applicant: FUJI XEROX CO., LTD., Tokyo (JP)

(72) Inventor: Tetsunori MURAKAMI, Kanagawa (JP)

(73) Assignee: FUJI XEROX CO., LTD., Tokyo (JP)

(21) Appl. No.: 15/347,008

(22) Filed: Nov. 9, 2016

(30) Foreign Application Priority Data
Jun. 7, 2016 (JP) 2016-113431

(51) Int. Cl. G06F 21/60; G06F 21/62

(52) U.S. Cl. CPC G06F 21/606; G06F 21/6218

(57) ABSTRACT

An information processing system includes a first apparatus and at least one second apparatus. The first apparatus includes a unit that receives input of data, a storage unit that stores concealed data corresponding to the input data with a concealment target thereof concealed, a unit that, if instructed by a user to refer to the stored concealed data, transmits a reference request containing information indicating the user to the second apparatus, and a unit that, if provided with reconstruction information from the second apparatus, reconstructs the concealment target with the reconstruction information. The second apparatus includes a memory that stores the reconstruction information, a determining unit that makes a determination on reference authority of the user to the reconstruction information, and a responding unit that provides the first apparatus with the reconstruction information if the determining unit determines that the user has reference authority to the concealment target.

### CROSS-REFERENCE TO RELATED APPLICATIONS

This application is based on and claims priority under 35 USC 119 from Japanese Patent Application No. 2016-113431 filed Jun. 7, 2016.

### BACKGROUND

### (i) Technical Field

The present invention relates to an information processing system, an information processing apparatus, a non-transitory computer readable medium, and an information processing method.

### (ii) Related Art

Data created and stored by an organization such as a company may include information required to be strictly managed (referred to as management-requiring information), such as so-called Individual Numbers (social security and tax numbers). When storing such data, it is required to prevent the management-requiring information in the data from being referred to by any unauthorized person. This requirement may be satisfied by storing the data with the management-requiring information simply deleted therefrom. The stored data, however, lacks the management-requiring information, and thus may fail to function as evidence or trace in a future investigation such as an operational audit.

### SUMMARY

According to an aspect of the invention, there is provided an information processing system including a first apparatus and at least one second apparatus. The first apparatus includes a unit that receives input of data to be stored, a storage unit that stores concealed data corresponding to the input data with a concealment target thereof concealed, a unit that, if instructed by a user to refer to the stored concealed data, transmits a reference request containing information indicating the user to the at least one second apparatus, and a unit that, if provided with reconstruction information from the at least one second apparatus in accordance with the reference request, reconstructs the concealed concealment target in the concealed data with the reconstruction information. The at least one second apparatus includes a memory, a determining unit, and a responding unit. The memory stores the reconstruction information for reconstructing the concealment target concealed in the concealed data stored in the storage unit. The determining unit makes a determination on reference authority of the user to the reconstruction information in the memory. The responding unit provides the first apparatus with the reconstruction information corresponding to the concealment target, if the determining unit determines that the user indicated by the information of the reference request from the first apparatus has reference authority to the concealment target. The responding unit does not provide the first apparatus with the reconstruction information, if the determining unit determines that the user does not have the reference authority to the concealment target.

### BRIEF DESCRIPTION OF THE DRAWINGS

An exemplary embodiment of the present invention will be described in detail based on the following figures, wherein:

FIG. 1 is a diagram illustrating an example of a system of the exemplary embodiment;

FIG. 2 is a diagram illustrating an example of an internal configuration of a concealment determining unit, a concealed information storage unit, and a reference determining unit in a concealed information management system;

FIG. 3 is a diagram for describing a process performed by the concealment determining unit;

FIG. 4 is a diagram for describing a process performed by the reference determining unit;

FIG. 5 is a diagram illustrating a system configuration including plural regular operation systems and plural concealed information management systems;

FIG. 6 is a diagram for describing a process in which a regular operation system conceals concealment target information in plural categories in cooperation with plural concealed information management systems provided for the respective categories of the concealment target information; and

FIG. 7 is a diagram for describing a process in which the regular operation system reconstructs the concealment target information by obtaining reconstruction information from the plural concealed information management systems provided for the respective categories of the concealment target information.

### DETAILED DESCRIPTION

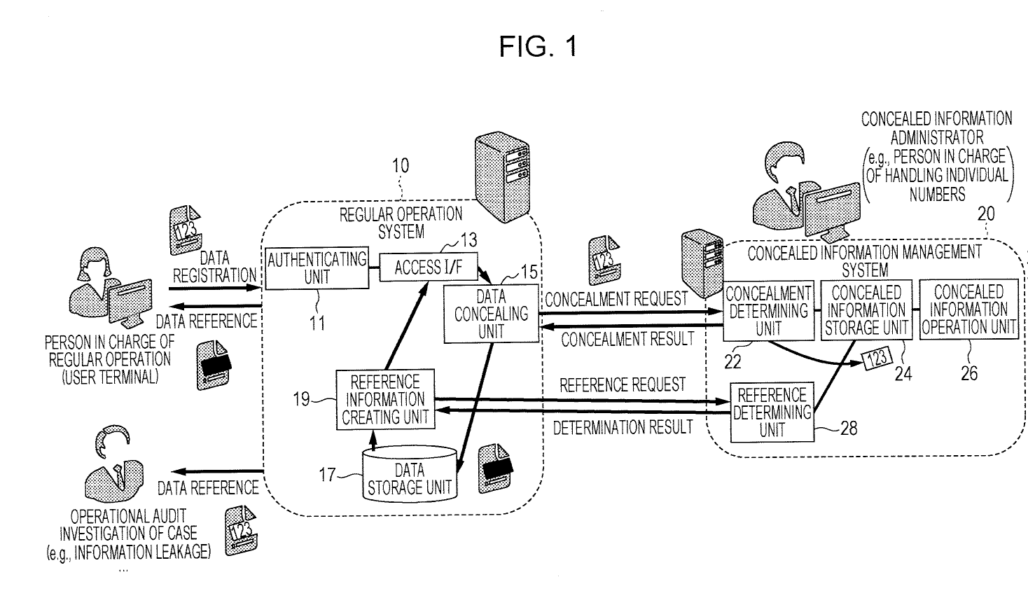

A system configuration of an exemplary embodiment of the present invention will be described with reference to FIG. 1. For example, the system of the present exemplary embodiment is assumed to be a system installed in an organization such as a company to store documents and other data used for the operation of the organization. This system further provides the stored data to a user for a purpose such as reference or editing. Data to be stored in this system may include concealment target information determined by the organization. The concealment target information refers to information determined to be concealed from general users inside the organization and users outside the organization in accordance with laws and ordinances or regulations and policies of the organization. An example of the concealment target information is Individual Numbers (social security and tax numbers) of individuals stipulated by so-called the Individual Number Act. Individual Numbers are required by laws and ordinances to be managed to be unobtainable by users inside an organization other than a specific user in charge of handling Individual Numbers. Further, it is undesirable in terms of trade secret management to allow information of product development and so forth or financial management information to be exposed to parties other than members of the related department. Thus, such information may be treated as the concealment target information. Terms ethically undesirable to be explicitly stated in data, such as words banned from being broadcast, may also be concealed as the concealment target information. As described above, various types of information are conceivable as the concealment target information, and each organization determines what kind of information should be treated as the concealment target information in light of the operational purposes thereof.

In the present exemplary embodiment, the concealment target information in the data stored for the regular operation is concealed, and the concealed information is controlled to be accessible only to a specific authorized user.

As illustrated in FIG. 1, the system of the present exemplary embodiment includes a regular operation system 10 and a concealed information management system 20.

The regular operation system 10, which is a system that performs information processing for the operation of an organization, stores data for the operation and provides the stored data to a user. The organization may have plural regular operation systems 10 built for respective purposes. For instance, a document management system, a financial information management system, a development information management system, a production information management system, a client information management system, a sales information management system, and a distribution information management system are examples of the regular operation systems 10. The regular operation system 10 stores the data for the operation in a data storage unit 17, but conceals the concealment target information contained in the stored data.

The concealed information management system 20 manages a process of deleting the concealment target information from the data stored by the regular operation system 10, and stores the deleted concealment target information. The concealed information management system 20 further performs control for providing the stored concealment target information to a user having appropriate authority. The concealed information management system 20 is a system that executes processing in accordance with a request from the regular operation system 10, and does not accept access from general users (persons in charge of the regular operation). The user allowed to access the concealed information management system 20 is limited to a person or administrator in charge of the management of the concealment target information.

Details of each of these systems will be described below.

The regular operation system 10 includes an authenticating unit 11, an access interface (I/F) 13, a data concealing unit 15, the data storage unit 17, and a reference information creating unit 19 as internal functions thereof.

The authenticating unit 11 performs login authentication of a user who attempts to use the regular operation system 10. If a user accesses the regular operation system 10 from his or her personal computer (PC), for example, the user is first subjected to the authentication by the authenticating unit 11. If successfully authenticated, the user is allowed to use information processing functions provided by the regular operation system 10. The provided information processing functions include a function of registering data, such as a document edited by the user, in the regular operation system 10 and a function of providing the data stored in the regular operation system 10 to the user for a purpose such as reference or editing of the data.

The data storage unit 17 stores the data to be stored registered by the user. The data storage unit 17 includes a fixed storage device, such as a hard disk drive (HDD) or a solid state drive (SSD), for example.

The access I/F 13 executes an interface process for the access of the user to the data storage unit 17. Herein, examples of the access to the data storage unit 17 include access for registering data in the data storage unit 17 and access for referring to (acquiring, for example) data stored in the data storage unit 17.

The access I/F 13 further executes control of the access to the data stored in the data storage unit 17. Therefore, the access I/F 13 has information for determining the access right (reference authority) of the user to each of data items in the data storage unit 17 (an access control list, for example). Based on this information, the access I/F 13 determines whether or not the user having requested to refer to (access) a data item in the data storage unit 17 has the reference authority to the data item. Then, if the user has the access right to the data item, the access I/F 13 provides the data item to the user. If not, the access I/F 13 refuses to provide the data item to the user.

Herein, the management of the access right by the access I/F 13 is independent of the management of the access right to the concealment target information performed by a reference determining unit 28 of the later-described concealed information management system 20. That is, as described in detail later, the data stored in the data storage unit 17 is concealed data corresponding to the data registered by the user with the concealment target information thereof concealed. In the management of the access right by the access I/F 13, whether or not the user is allowed to refer to the concealed data is determined. Even if the user is allowed to refer to the concealed data, this merely indicates that the user is allowed to obtain the concealed data in which the concealment target information is concealed. To also obtain the concealment target information in the concealed data, the user needs to be determined by the reference determining unit 28 of the concealed information management system 20 to have the reference authority to the concealment target information.

The data concealing unit 15 executes a process of concealing the concealment target information in the data to be stored in the data storage unit 17. The data concealing unit 15 executes this concealment process under the management of the concealed information management system 20. That is, the data concealing unit 15 per se does not detect the concealment target information contained in the data to be stored, but hands the data to the concealed information management system 20 to have the concealed information management system 20 detect the concealment target information in the data. Then, for example, the data concealing unit 15 receives from the concealed information management system 20 identification information identifying which information in the data to be stored is the detected concealment target information, and conceals the concealment target information in the data to be stored in accordance with the identification information. The data concealing unit 15 stores in the data storage unit 17 the concealed data obtained by concealing all concealment target information in the data. In place of the configuration in which the data concealing unit 15 conceals the concealment target information in the data based on the information from the concealed information management system 20, the concealed information management system 20 may create from the received data to be stored the concealed data in which the concealment target information is concealed, and return the created concealed data to the data concealing unit 15. In this case, the data concealing unit 15 registers the received concealed data in the data storage unit 17 in place of the data instructed to be stored by the user.

The concealment target information is concealed to prevent any user from referring to the concealment target information in the data. For example, the data concealing unit 15 replaces the concealment target information contained in the data to be stored with substitute information. In this example, the concealment target information in the data is deleted and replaced by the substitute information, and thus the concealment target information disappears from the data. The substitute information replacing the concealment target information may be, for example, a solid black rectangle or a predetermined specific character code (the asterisk or the space character, for example). The concealment is not limited to the replacement by the substitute information, and may be performed by simply deleting the concealment target information from the data to be stored. Each of the replacement by the substitute information and the simple deletion is a method of erasing the concealment target information itself from the data. However, the concealment is not limited to this type of method. This method may be replaced by, for example, a method of encoding the concealment target information to conceal the concealment target information. In this case, the concealed data contains the encoded concealment target information. The concealment target information in the concealed data appears to be meaningless data to the user unless the concealment target information is decoded. The concealment methods described above as examples are only illustrative, and another concealment method may be employed in the present exemplary embodiment.

The data to be stored input by the user is all subjected to the concealment process by the data concealing unit 15 before being stored in the data storage unit 17. All data stored in the data storage unit 17 is thus the concealed data in which the concealment target information is concealed. Therefore, even a user with the access right to all data in the regular operation system 10, such as a system administrator of the regular operation system 10, is allowed to refer only to the concealed data with his or her access right, and is not allowed to refer to the concealment target information in the concealed data with the access right. If the system administrator of the regular operation system 10 intends to refer to the concealment target information in the concealed data, the system administrator needs to obtain the access right to the concealment target information.

The reference information creating unit 19 creates reference data to be provided to the user in accordance with an instruction from the user to refer to the data in the data storage unit 17. The reference data to be provided to the user is obtained by performing a process of reconstructing the concealment target information on the data in the data storage unit 17 (the concealed data, that is, data obtained by concealing the concealment target information in the original data) in accordance with the authority of the user. For example, if the user having issued the reference request has the reference authority to the concealment target information in the concealed data (an auditor who conducts an operational audit related to the regular operation system 10, for example), the reference information creating unit 19 obtains the concealment target information from the concealed information management system 20, generates data by incorporating the concealment target information in the concealed data to be referred to, and provides the generated data to the user. Meanwhile, if the user as the reference request source does not have the reference authority to the concealment target information in the concealed data, the reference information creating unit 19 provides the user with the concealed data in which the concealment target information remains concealed.

In the system of the present exemplary embodiment, whether or not the user having issued the reference request has the reference authority to each of concealment target information items in the requested data is determined not by the reference information creating unit 19 but by the concealed information management system 20. That is, the reference information creating unit 19 transmits to the concealed information management system 20 a reference determination request, which includes information identifying the user as the reference request source (a user identification (ID) information, for example) and information identifying the concealment target information item to be referred to. After receiving the reference determination request, the concealed information management system 20 determines whether or not the user as the reference request source has the reference authority to the concealment target information item to be referred to, and returns a determination result to the reference information creating unit 19. The determination result includes concealment target information item to which the user has the reference authority.

The concealed information management system 20 includes a concealment determining unit 22, a concealed information storage unit 24, a concealed information operation unit 26, and the reference determining unit 28.

The concealment determining unit 22 analyzes the data to be stored, for which the concealment determining unit 22 has received the request for determination on concealment from the regular operation system 10 (the data concealing unit 15), to find whether or not the data contains the concealment target information. The method of this analysis may be any method already existing or to be developed in the future, and thus description thereof will be omitted. The concealment determining unit 22 then returns information identifying the concealment target information detected in the data to be stored (information indicating the area of existence of the concealment target information in the data, for example) to the regular operation system 10. In the example employing the concealment method of replacing the concealment target information with the substitute information, the concealment determining unit 22 may provide the regular operation system 10 with the substitute information in addition to the information identifying the concealment target information. Alternatively, the concealment determining unit 22 may generate the concealed data by concealing the detected concealment target information (replacing the concealment target information with the substitute information, for example), and return the generated concealed data to the regular operation system 10.

The concealment determining unit 22 further registers the detected concealment target information in the concealed information storage unit 24.

The concealed information storage unit 24 stores the concealment target information detected in the data by the concealment determining unit 22 in association with an ID of the data. The concealed information storage unit 24 has a function of managing the access to the stored concealment target information.

The concealed information operation unit 26 is a functional module used by the administrator of the concealed information management system 20 to operate the settings and other information in the concealed information management system 20. For example, with the concealed information operation unit 26, the administrator performs operations such as setting and changing of the access right of the user to the concealment target information stored in the concealed information storage unit 24. For example, on the day of an operational audit, the administrator performs an operation such as providing the auditor in charge of the operational audit with the reference authority to the concealment target information in the concealed information storage unit 24.

The reference determining unit 28 determines whether or not the user as the request source indicated by the reference determination request from the regular operation system 10 (the reference information creating unit 19) has the reference authority to each of the concealment target information items in the data requested to be referred to. This determination may be performed by inquiry to the access management function of the concealed information storage unit 24. The reference determining unit 28 further provides the regular operation system 10 with the concealment target information item, to which the user as the request source has been determined to have the reference authority.

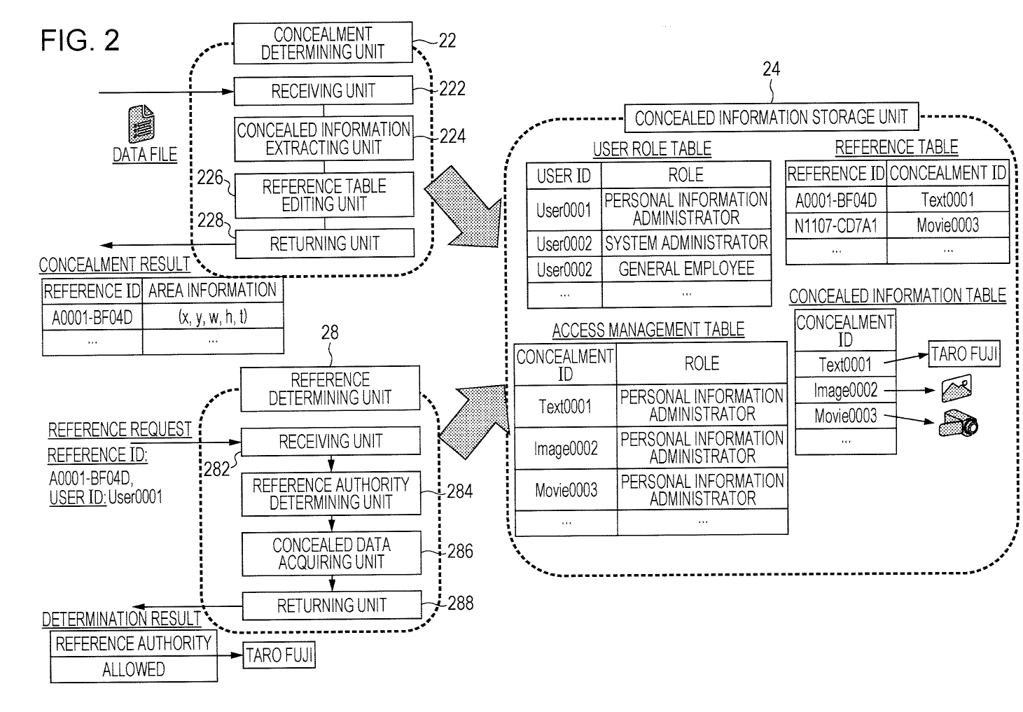

The concealment determining unit 22, the concealed information storage unit 24, and the reference determining unit 28 of the concealed information management system 20 will now be described in further detail with reference to FIG. 2.

The concealed information storage unit 24 holds a concealed information table, a reference table, a user role table, and an access management table.

The concealed information table is a table that holds concealment target information items concealed in the data to be stored. The concealment target information items themselves concealed in the data to be stored (such as text data, image data, or multimedia data, for example) are registered in the concealed information table in association with respective concealment IDs, which are identification information assigned to the concealment target information items by the concealed information storage unit 24.

The reference table is a table that holds the correspondence relationship between each of the concealment IDs of the concealment target information items registered in the concealed information table and a corresponding reference ID. The reference ID is identification information that is provided to the regular operation system 10 as an ID indicating the corresponding concealed concealment target information item, and is a unique value different for each concealment target information item. The concealment ID itself may be provided to the regular operation system 10 as the reference ID, in which case the reference table is unnecessary.

The user role table is a table that holds respective roles of users in association with respective user IDs of the users. The illustrated example presents roles such as personal information administrator, system administrator, and general employee as examples of the roles.

The access management table is a table that holds access management information for the respective concealment target information items stored in the concealed information table. In the illustrated example, for each of the stored concealment target information items, the concealment ID of the concealment target information item and the role having the reference authority to the concealment target information item are registered in this table. In the illustrated example, all of three concealment target information items stored in the concealed information table are allowed to be referred to only by a user with the role “personal information administrator” (corresponding to a user with user ID “User0001” in the illustrated example). As well as the roles, the user IDs of individuals may of course be registered as information indicating any user having the reference authority to the concealment target information items.

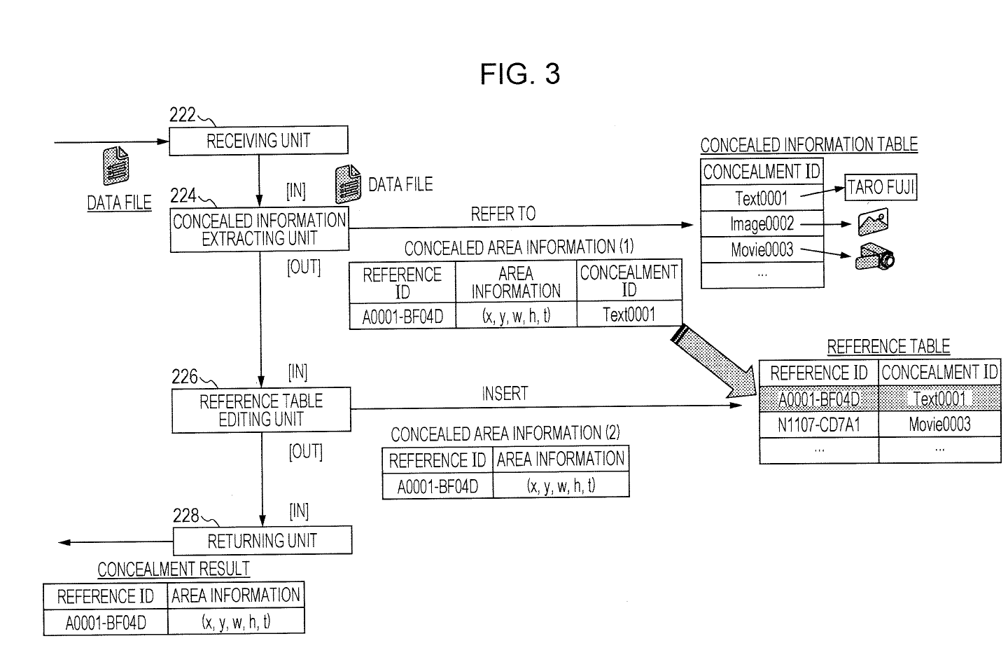

The concealment determining unit 22 detects the concealment target information in the data to be stored received from the regular operation system 10, and returns the information indicating the detected concealment target information to the regular operation system 10. The concealment determining unit 22 includes a receiving unit 222, a concealed information extracting unit 224, a reference table editing unit 226, and a returning unit 228 as internal functions thereof. The operations of these internal functions will be described below with reference also to FIG. 3.

The receiving unit 222 receives from the data concealing unit 15 of the regular operation system 10 a concealment determination request including the data to be subjected to the determination (that is, the data instructed to be stored by the user). The data to be subjected to the determination is input to the receiving unit 222 in the form of a data file, for example. This data is handed to the concealed information extracting unit 224.

The concealed information extracting unit 224 analyses the data to be subjected to the determination received from the receiving unit 222, and extracts portions of the data meeting conditions of the concealment target as concealment target information items. In this process, the concealed information extracting unit 224 also obtains area information indicating the area of existence of each of the extracted concealment target information items in the data. For example, if the data to be subjected to the determination is a document formed of plural pages, the area information is expressed by the combination of the number of the page including the concealment target information item and information indicating the area of existence of the concealment target information item in the page (if the area of existence is a rectangle, for example, the coordinates of two mutually facing vertices of the rectangle). Further, if the data to be subjected to the determination is text data, the area information may indicate the initial and final characters (or the initial and final bytes) of a portion of the text data corresponding to the concealment target information item. Further, if the data to be subjected to the determination is video data, the area information is expressed by the combination of information identifying a frame containing the concealment target information item (the time elapsed from the beginning of the video, for example) and information of the area of existence of the concealment target information item in the frame. The forms of expression of the area information of the concealment target information item described here are only illustrative.

The concealed information extracting unit 224 further assigns the unique concealment ID to each of the extracted concealment target information items, and stores the concealment target information item in the concealed information table in association with the concealment ID. The concealed information extracting unit 224 further generates the unique reference ID for the concealment target information item. Then, for each of the extracted concealment target information items, the concealed information extracting unit 224 hands a group of the reference ID, the area information, and the concealment ID to the reference table editing unit 226.

The reference table editing unit 226 registers in the reference table a pair of the reference ID and the concealment ID from the information received from the concealed information extracting unit 224 (the reference ID, the area information, and the concealment ID). The reference table editing unit 226 then hands a pair of the reference ID and the area information to the returning unit 228. The reference table editing unit 226 performs the above-described process for each of the extracted concealment target information items.

For each of the extracted concealment target information items, the returning unit 228 returns the reference ID and the area information received from the reference table editing unit 226 to the data concealing unit 15 of the regular operation system 10.

The data concealing unit 15 receives from the returning unit 228 the pairs of the reference ID and the area information for the respective concealment target information items, and conceals, for each of the pairs, the area in the data to be stored indicated by the area information in the pair (replaces the area with the predetermined substitute information, for example). The data concealing unit 15 then registers data obtained by preforming the concealment on all of the pairs in the data storage unit 17 as the concealed data. The data concealing unit 15 further associates each of the concealed portions in the concealed data (the substitute information or the position at which the concealment target information item is deleted, for example) with the corresponding reference ID. This association may be performed by, for example, including the reference ID in the concealed portion in the concealed data as metadata, for example. Further, as another example, the pairs of the reference ID and the area information for the respective concealment target information items received from the returning unit 228 may themselves be registered in the data storage unit 17 in association with the concealed data. Any method may be employed as long as the method enables identification of the individual concealed portions included in the concealed data and the reference IDs corresponding to the concealed portions when the user requests to refer to the concealed data.

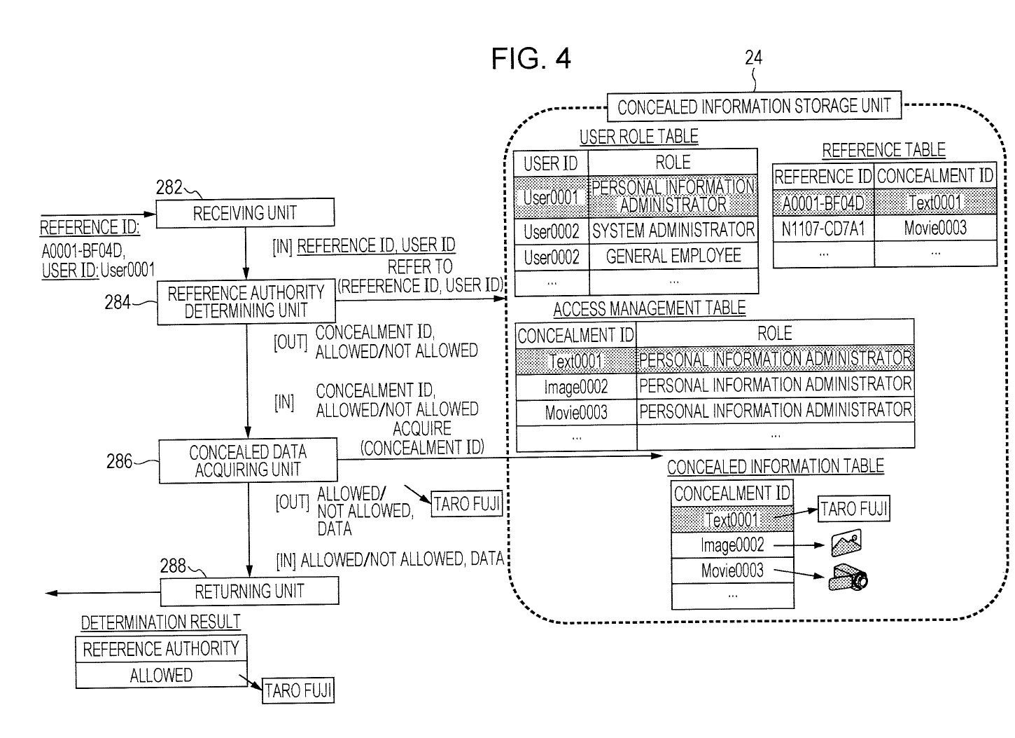

The reference determining unit 28 will now be described with reference to FIGS. 2 and 4. In response to the request from the regular operation system 10, the reference determining unit 28 determines whether the user has the reference authority to the corresponding concealment target information item, and returns the determination result. Further, if the user has the reference authority to the concealment target information item, the reference determining unit 28 provides the regular operation system 10 with reconstruction information for reconstructing the concealed portion in the concealed data corresponding to the concealment target information item (that is, cancelling the concealed state and restoring the original concealment target information item). For example, the reconstruction information is the concealment target information item itself deleted from the concealed data. The reference determining unit 28 includes a receiving unit 282, a reference authority determining unit 284, a concealed data acquiring unit 286, and a returning unit 288 as internal functions thereof.

For instance, a description will be given, with reference to FIG. 4, of an example in which the reference information creating unit 19 of the regular operation system 10 transmits the reference request to the reference determining unit 28 for each of the concealed portions in the concealed data. In this example, after receiving the instruction from the user to refer to the concealed data in the data storage unit 17, the reference information creating unit 19 analyzes the concealed data. Then, each time a concealed portion is found in the concealed data, the reference information creating unit 19 transmits the reference request to refer to the concealed portion to the reference determining unit 28. The reference request contains the user ID of the user and the reference ID associated with the concealed portion.

The receiving unit 282 receives the reference request from the reference information creating unit 19 of the regular operation system 10, and hands the information of the received reference request, that is, the pair of the user ID and the reference ID, to the reference authority determining unit 284.

The reference authority determining unit 284 determines whether or not the user corresponding to the user ID in the received reference request has the reference authority to the concealment target information item corresponding to the reference ID in the reference request. The reference authority determining unit 284 makes this determination with reference to the reference table, the access management table, and the user role table in the concealed information storage unit 24. That is, the reference authority determining unit 284 obtains from the reference table the concealment ID corresponding to the reference ID in the reference request, and obtains from the access management table the role having the reference authority to the concealment target information item corresponding to the obtained concealment ID. The reference authority determining unit 284 further obtains from the user role table the role corresponding to the user ID in the reference request. Then, the reference authority determining unit 284 checks if the obtained role corresponds to the role having the reference authority to the concealment target information item corresponding to the previously obtained concealment ID. If the obtained role corresponds to the role having the reference authority to the concealment target information item corresponding to the concealment ID, the reference authority determining unit 284 determines that the user as the request source is allowed to refer to (has the reference authority to) the requested concealment target information item. If not, the reference authority determining unit 284 determines that the user is not allowed to refer to the requested concealment target information item. The reference authority determining unit 284 hands a pair of the concealment ID and information as to the reference authority representing the result of this determination to the concealed data acquiring unit 286. For example, even the system administrator of the regular operation system 10 is not allowed to see the concealment target information item in the concealed data, unless being determined by the reference determining unit 28 to have the reference authority to the concealment target information item.

If the information as to reference authority in the received pair indicates that the user is allowed to refer to the concealment target information item, the concealed data acquiring unit 286 acquires the concealment target information item corresponding to the concealment ID in the pair from the concealed information table in the concealed information storage unit 24. The concealed data acquiring unit 286 then hands to the returning unit 288 the acquired concealment target information item and the information indicating that the user is allowed to refer to the concealment target information item.

The returning unit 288 returns to the reference information creating unit 19 of the regular operation system 10 a response (determination result) including the determination result on the reference authority and the concealment target information item acquired by the concealed data acquiring unit 286 (only if the user is determined to be allowed to refer to the concealment target information item).

The reference information creating unit 19 receives the response to the reference request from the concealed information management system 20. Then, if the response indicates that the user is “allowed to refer to” the concealment target information item, the reference information creating unit 19 substitutes the concealment target information item contained in the response for the corresponding concealed portion in the concealed data. Meanwhile, if the response indicates that the user is “not allowed to refer to” the concealment target information item, the reference information creating unit 19 keeps the concealed portion corresponding to the reference request concealed.

The above-described process is performed for all of the concealed portions in the concealed data requested to be referred to by the user. Thereby, any concealment target information item in the concealed data to which the user has the reference authority is displayed, and any concealment target information item in the concealed data to which the user does not have the reference authority is generated as still concealed data.

It is assumed in the example of FIG. 4 that, for each of embedded portions in the concealed data, the reference request for the reference ID corresponding to the embedded portion is transmitted from the reference information creating unit 19 to the reference determining unit 28. However, this is only illustrative, and the reference information creating unit 19 may transmit to the reference determining unit 28 a reference request collectively containing the respective reference IDs corresponding to the concealed portions included in one concealed data item. In this case, the reference determining unit 28 makes the determination on the reference authority for each of the reference IDs contained in the reference request with a method similar to the above-described method. The reference determining unit 28 then returns the result of the determination for each of the reference IDs (the information as to the reference authority, and the concealment target information item if the user is allowed to refer thereto) to the reference information creating unit 19 in association with the reference ID.

In the foregoing examples described with reference to FIGS. 2 to 4, the concealment target information is deleted from the data to be stored (the deleted concealment target information is replaced with the substitute information in one of the examples), and is stored by the concealed information management system 20. As another example, the concealment target information may be concealed by encoding.

In this example, for each of the concealment target information items detected in the data to be stored, the concealment determining unit 22 generates an encoding key and a decoding key (which may be the same) corresponding to the concealment target information item, and stores the decoding key, in place of the concealment target information item, in the concealed information table (see FIG. 2) in association with the concealment ID of the concealment target information item. The concealment determining unit 22 then returns the area information identifying the detected concealment target information item, the reference ID, and the encoding key to the data concealing unit 15 of the regular operation system 10. With the encoding key, the data concealing unit 15 encodes the concealment target information item in the data to be stored, to thereby conceal the concealment target information item. Alternatively, the concealment determining unit 22 may encode the concealment target information item with the encoding key and return the encoded concealment target information item, the area information, and the reference ID to the data concealing unit 15, and the data concealing unit 15 may replace the concealment target information item indicated by the area information with the encoded concealment target information item. When referring to the concealed data, the reference determining unit 28 reads from the concealed information table the decoding key corresponding to the concealment target information item corresponding to the reference request from the reference information creating unit 19, and returns the decoding key to the reference information creating unit 19. With the decoding key, the reference information creating unit 19 decodes the encoded concealment target information item, to thereby reconstruct the original concealment target information item. In this example, the decoding key is the reconstruction information for reconstructing the concealed concealment target information item (that is, cancelling the concealed state).

The system including one regular operation system 10 and one concealed information management system 20 has been described above as an example. The system of the present exemplary embodiment, however, may include plural regular operation systems 10, or may include plural concealed information management systems 20.

For example, a system is conceivable in which plural regular operation systems 10 provided for respective purposes, such as a document management system, a financial information system, and a production management system in an organization, cooperate as described above with a concealed information management system 20 shared thereby to manage the concealment target information.

Further, as an example employing plural concealed information management systems 20, separate concealed information management systems 20 may be used for respective categories of the concealment target information.

For example, the Individual Numbers and the financial information are subject to the concealment for different reasons (laws and ordinances or in-house rules), and are generally handled by different departments or persons. Access to the financial information by a person in charge of handling the Individual Numbers or access to the concealed Individual Numbers by a person in charge of accounting needs to be prevented for information management. When the Individual Numbers and the financial information are managed with one concealed information management system 20, it is of course possible to achieve a major purpose of the management by performing control to prohibit such access to concealed information beyond related work through the management of the access right. However, a system administrator of this concealed information management system 20 is capable of accessing both types of information, which raises an issue in the information management. By contrast, if separate concealed information management systems 20 are provided for the respective categories of the concealment target information, such as the concealed information management system 20 for the Individual Numbers and the concealed information management system 20 for the financial information, such an issue is well addressed or mitigated.

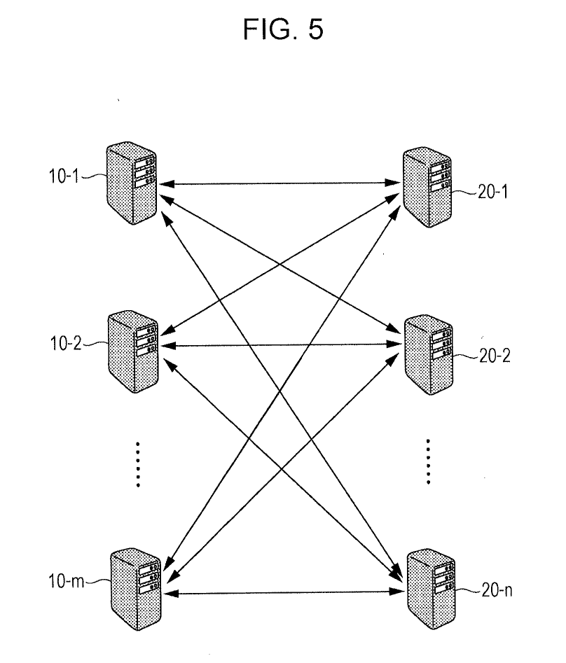

As illustrated in FIG. 5, it is of course also possible to provide a system configuration in which each of plural regular operation systems 10-1 to 10-m uses plural concealed information management systems 20-1 to 20-n provided for the respective categories (each of m and n represents an integer equal to or greater than 2).

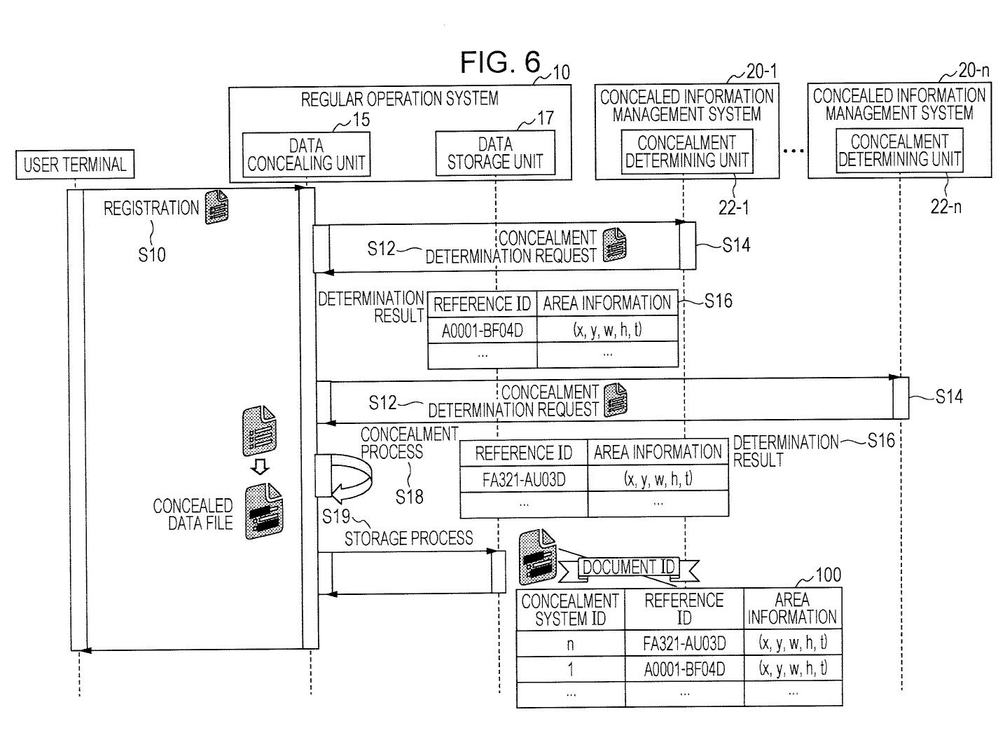

With reference to FIG. 6, a description will now be given of an example of the data registration process performed when there are plural concealed information management systems 20.

If an instruction to register data is issued from a user terminal to a regular operation system 10 (step S10), the data concealing unit 15 of the regular operation system 10 transmits a concealment determination request containing the data to the plural concealed information management systems 20-1 to 20-n preset as inquiry destinations (step S12).

After receiving the concealment determination request, each of concealment determining units 22-1 to 22-n of the concealed information management systems 20-1 to 20-n extracts, from the target data contained in the request, concealment target information items of the category handled by the corresponding one of the concealed information management systems 20-1 to 20-n, and stores the extracted concealment target information items (step S14). Then, the each of the concealment determining units 22-1 to 22-n returns to the data concealing unit 15 the reference ID assigned to each of the extracted concealment target information items and the area information indicating the area of existence of the concealment target information item (step S16).

For each of pairs of the reference ID and the area information received from the respective concealment determining units 22-1 to 22-n, the data concealing unit 15 conceals a portion of the target data indicated by the area information (that is, the concealment target information item) (step S18). With the concealment process performed on all of the pairs, concealed data is obtained in which the concealment target information items in all preset categories are concealed. The data concealing unit 15 stores the concealed data in the data storage unit 17 in association with a unique ID (document ID) (step S19). The data concealing unit 15 further stores information 100 of the pairs of the reference ID and the area information of the respective concealed concealment target information items in the data storage unit 17 in association with the document ID of the stored concealed data. In association with each of the pairs, identification information (a concealment system ID) of the corresponding one of the concealed information management systems 20-1 to 20-n having provided the information of the pair as the response to the concealment determination request is recorded in the information 100.

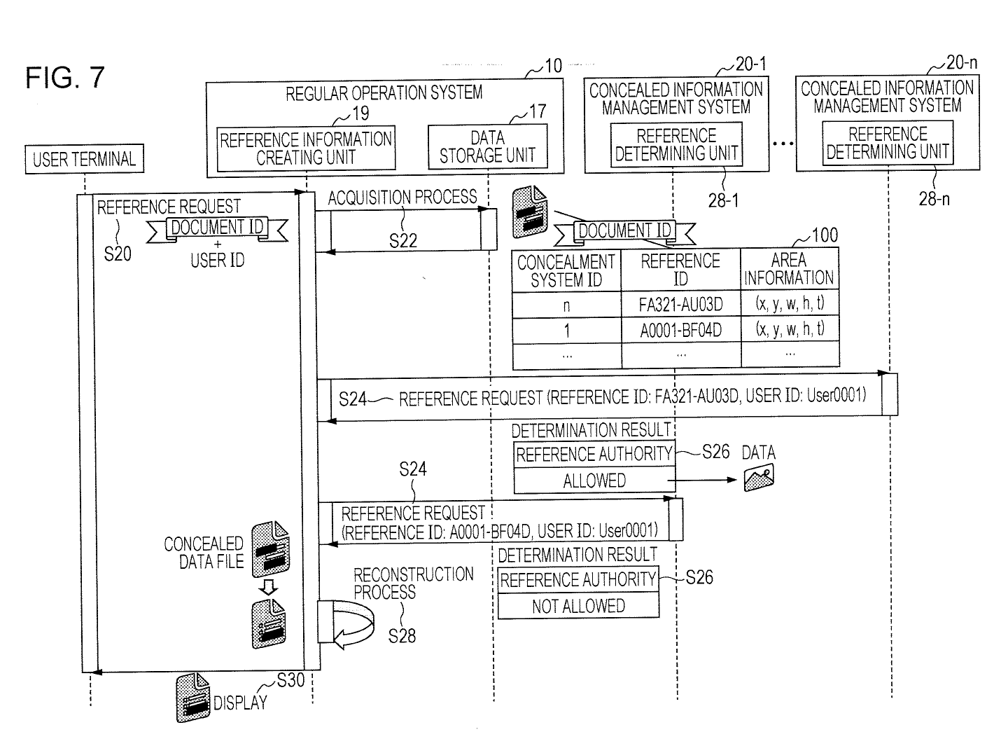

With reference to FIG. 7, a description will now be given of an example of the process of referring to the concealed data performed when there are plural concealed information management systems 20.

A user logs in the regular operation system 10 by operating a user terminal, and specifies a document to be referred to in a list of documents (concealed data items) presented by the regular operation system 10. Then, the user terminal transmits to the reference information creating unit 19 of the regular operation system 10 a reference request containing the document ID of the specified document and the user ID of the user (step S20). The reference information creating unit 19 acquires from the data storage unit 17 the concealed data corresponding to the target document ID in the reference request (step S22). The acquired concealed data is associated with the information 100 formed of entries including the pairs of the reference ID and the area information corresponding to the respective concealed portions in the concealed data and the concealment system IDs of the concealed information management systems 20-1 to 20-n having provided the pairs. For each of the entries in the information 100, the reference information creating unit 19 transmits the reference request containing the reference ID in the entry and the user ID of the request source to one of the concealed information management systems 20-1 to 20-n corresponding to the concealment system ID in the entry (step S24).

After receiving the reference request, each of reference determining units 28-1 to 28-n of the concealed information management systems 20-1 to 20-n determines from the user ID in the reference request whether or not the user corresponding to the user ID is allowed to refer to the concealment target information item corresponding to the reference ID in the reference request, and returns a determination result to the reference information creating unit 19 (step S26). In the illustrated example, the reference determining unit 28-n determines that the requested concealment target information item of the reference ID “FA321-AU03D” is allowed to be referred to by the user, and returns a determination result containing the concealment target information item to the reference information creating unit 19. Meanwhile, the reference determining unit 28-1 determines that the requested concealment target information item of the reference ID “A0001-BF04D” is not allowed to be referred to by the user, and returns to the reference information creating unit 19 a determination result (not containing the concealment target information item) informing that the concealment target information item is not allowed to be referred to by the user.

The reference information creating unit 19 reconstructs the concealment target information items contained in the determination results received from the reference determining units 28-1 to 28-n at the respective locations of the corresponding concealed portions in the concealed data (step S28). Thereby, data is generated in which only the concealment target information items to which the user has the reference authority are reconstructed, and the data is provided to the user terminal (step S30).

Each of the regular operation system 10 and the concealed information management system 20 described above is realized by causing a computer to execute a program representing the above-described functions of each of these systems. Herein, for example, the computer includes, as hardware, a circuit configuration in which a microprocessor such as a central processing unit (CPU), memories (primary memories) such as a random access memory (RAM) and a read-only memory (ROM), a controller that controls a fixed storage device such as a flash memory, a solid state drive (SSD), or a hard disk drive (HDD), various input/output (I/O) interfaces, and a network interface that performs control for connection with a network such as a local area network, are connected via a bus, for example. The program describing processing contents of these functions is stored in the fixed storage device such as the flash memory via the network, for example, and is installed in the computer. The program stored in the fixed storage device is read into the RAM and executed by the microprocessor such as the CPU, to thereby realize the functional modules described above as examples. Further, at least one of the regular operation system 10 and the concealed information management system 20 may be configured of two or more computers that cooperate with each other through communication.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising a first apparatus and at least one second apparatus,
the first apparatus including
a unit that receives input of data to be stored,
a storage unit that stores concealed data corresponding to the input data with a concealment target thereof concealed,
a unit that, if instructed by a user to refer to the stored concealed data, transmits a reference request containing information indicating the user to the at least one second apparatus, and
a unit that, if provided with reconstruction information from the at least one second apparatus in accordance with the reference request, reconstructs the concealed concealment target in the concealed data with the reconstruction information, and
the at least one second apparatus including
a memory that stores the reconstruction information for reconstructing the concealment target concealed in the concealed data stored in the storage unit,
a determining unit that makes a determination on reference authority of the user to the reconstruction information in the memory, and
a responding unit that provides the first apparatus with the reconstruction information corresponding to the concealment target if the determining unit determines that the user indicated by the information of the reference request from the first apparatus has reference authority to the concealment target, and does not provide the first apparatus with the reconstruction information if the determining unit determines that the user does not have the reference authority to the concealment target.

2. The information processing system according to claim 1,
wherein the first apparatus further include
a transmitting unit that transmits to the at least one second apparatus a concealment request containing the input data to be stored, and
a generating unit that generates the concealed data by concealing the concealment target in the data to be stored with identification information identifying the concealment target and transmitted from the at least one second apparatus in accordance with the concealment request, and
wherein the at least one second apparatus further includes
a concealment target detector that detects the concealment target in the data contained in the concealment request from the first apparatus, and
a unit that transmits to the first apparatus the identification information identifying the detected concealment target.

3. The information processing system according to claim 2, wherein the at least one second apparatus includes a plurality of second apparatuses provided for respective categories of the concealment target,
wherein the concealment target detector of each of the plurality of second apparatuses detects in the data the concealment target belonging to a category corresponding to the each of the plurality of second apparatuses,
wherein the transmitting unit of the first apparatus transmits the data to be stored to the plurality of second apparatuses, and
wherein, with the identification information transmitted from each of the plurality of second apparatuses, the generating unit of the first apparatus conceals the concealment target in the data to be stored corresponding to the identification information.

4. An information processing apparatus comprising:
a unit that receives input of data to be stored;
a storage unit that stores concealed data corresponding to the input data with a concealment target thereof concealed;
a unit that, if instructed by a user to refer to the stored concealed data, transmits a reference request containing information indicating the user to a second apparatus that stores the concealment target in the concealed data and provides reconstruction information for reconstructing the concealment target if the user has reference authority to the concealment target; and
a unit that, if provided with the reconstruction information from the second apparatus in accordance with the reference request, reconstructs the concealed concealment target in the concealed data with the reconstruction information.

5. A non-transitory computer readable medium storing a program causing a computer to execute information processing, the processing comprising:
receiving input of data to be stored;
storing concealed data corresponding to the input data with a concealment target thereof concealed;
transmitting, in response to an instruction from a user to refer to the stored concealed data, a reference request containing information indicating the user to a second apparatus that stores the concealment target in the concealed data and provides reconstruction information for reconstructing the concealment target if the user has reference authority to the concealment target; and
reconstructing, if provided with the reconstruction information from the second apparatus in accordance with the reference request, the concealed concealment target in the concealed data with the reconstruction information.

6. An information processing apparatus comprising:
a memory that stores reconstruction information for reconstructing a concealment target of original data, which is concealed in corresponding concealed data stored in a first apparatus;
a determining unit that makes a determination on reference authority of a user to the reconstruction information in the memory; and
a responding unit that provides the first apparatus with the reconstruction information corresponding to the concealment target if the determining unit determines that the user as a request source of a reference request from the first apparatus to refer to the concealment target has reference authority to the concealment target, and does not provide the first apparatus with the reconstruction information if the determining unit determines that the user does not have the reference authority to the concealment target.

7. A non-transitory computer readable medium storing a program causing a computer to execute information processing, the processing comprising:
storing reconstruction information for reconstructing a concealment target of original data, which is concealed in corresponding concealed data stored in a first apparatus;
making a determination on reference authority of a user to the reconstruction information in the memory; and
providing the first apparatus with the reconstruction information corresponding to the concealment target if it is determined that the user as a request source of a reference request from the first apparatus to refer to the concealment target has reference authority to the concealment target, and not providing the first apparatus with the reconstruction information if it is determined that the user does not have the reference authority to the concealment target.

8. An information processing method comprising:
inputting data to be stored to a first apparatus;
storing concealed data in the first apparatus, the concealed data corresponding to the input data with a concealment target thereof concealed;
storing, in at least one second apparatus,
reconstruction information for reconstructing the concealment target concealed in the concealed data stored in the first apparatus;
transmitting, in response to an instruction from a user to refer to the stored concealed data, a reference request containing information indicating the user to the at least one second apparatus from the first apparatus;
making a determination, in the at least one second apparatus, on reference authority of the user to the stored reconstruction information;
providing the reconstruction information corresponding to the concealment target from the at least one second apparatus to the first apparatus, if it is determined that the user indicated by the information of the reference request from the first apparatus has reference authority to the concealment target, and not providing the reconstruction information from the at least one second apparatus to the first apparatus, if it is determined that the user does not have the reference authority to the concealment target; and
reconstructing, if the reconstruction information is provided to the first apparatus from the at least one second apparatus in accordance with the reference request, the concealed concealment target in the concealed data in the first apparatus with the reconstruction information.
